(19) United States
(12) Patent Application Publication
(10) Pub. No.: US 2007/0116539 A1
(43) Pub. Date: May 24, 2007

(54) Cutting Tool Assembly Having Three-Start Threaded Coupling system

(75) Inventors: Perry Malik, Karmiel (IL); Joseph Pano, Eilat (IL)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Iscar Ltd., Tefen (IL)

(21) Appl. No.: 11/553,846

(22) Filed: Oct. 27, 2006

(30) Foreign Application Priority Data
Nov. 22, 2005 (IL) 172121

(51) Int. Cl. F16B 25/00

(52) U.S. Cl. 411/386

(57) ABSTRACT

A cutting tool assembly has a tool longitudinal axis T defining front-to-rear direction and comprising a cutting-head threadingly secured to a tool shank. The cutting-head comprises a three-start, threaded head coupling portion having three head threads and the tool shank having a shank forward portion and comprises a three-start, threaded shank coupling portion having three shank threads. In the present invention, positioning repeatability, centering and coaxial alignment of the cutting tool assembly are provided by the threaded coupling of the cutting-head and the shank.

### FIELD OF THE INVENTION

The present invention relates to a cutting tool assembly and in particular to a cutting tool assembly employing threaded coupling to releasably secure replaceable cutting-heads to a tool shank.

### BACKGROUND OF THE INVENTION

Such cutting tool assemblies are known in the art. U.S. Pat. No. 6,485,220, for example, discloses a cutting tool assembly having a longitudinal axis A and comprising a male member and a female member. Each of the male and female members is formed with a threaded coupling portion, an annular abutment surface disposed perpendicularly to the longitudinal axis A and a frustoconical centering portion extending between the annular shoulder and the threaded coupling portion. The male member is mounted in the female member and rotated relative thereto, till the frustoconical centering portion and the annular abutment surface of the male member abuts the frustoconical centering portion and the annular abutment surface of the female member. The abutment between the frustoconical surfaces ensures concentricity between the male and the female members.

U.S. Pat. No. 5,114,286 discloses an interchangeable cutting tool alignment and positioning system comprising a first tool segment having a male coupler and a second tool segment having a female coupler. The male coupler comprises a pilot, a male thread and a concentric aligner. The female coupler comprises a pilot bore, a female thread and a concentric bore. When the male thread is fully engaged with the female thread, the pilot extends to within the pilot bore, and the concentric aligner extends to within the concentric bore. The diametrical sizing of the concentric aligner and the pilot must match that of the concentric bore and the pilot bore, respectively, to a very close tolerance, in order to provide means by which axial misalignment of the first and second tool segments is prevented. The close tolerance fit of the concentric aligner to the concentric bore and of the pilot to the pilot bore, acting in concert at either ends of the male and female threads, essentially prevents bending moments which may cause misalignment of the assembled tool segments about the tool rotational axis.

It is the object of the present invention to provide a cutting tool assembly in which the cutting-head and the shank are axially aligned by the threaded coupling thereof. This object is attained with the subject matter in accordance with the claims.

### SUMMARY OF THE INVENTION

In accordance with the present invention there is preferably provided a cutting tool assembly having a tool longitudinal axis T defining front-to-rear direction and comprising a cutting-head threadingly secured to a tool shank. The cutting-head comprises a three-start, threaded head coupling portion having three head threads. The tool shank has a shank forward portion which comprises a three-start, threaded shank coupling portion having three shank threads.

Preferably, the cutting-head comprises a forward cutting portion having a rearwardly facing cutting-head shoulder, and the tool-shank comprises a shank forward portion having a forwardly facing shank coupling shoulder in abutment with the cutting-head shoulder.

Further preferably, the cutting-head and tool shank shoulders are perpendicular to the tool longitudinal axis T.

Yet further preferably, the cutting-head and tool shank shoulders have an annular shape and are rotationally symmetrical with respect to the tool longitudinal axis T.

Typically, the three head threads have each a head thread start. The three head thread starts are circumferentially spaced apart from each other by a head thread start angle σ_{H}. The three shank threads have each a shank thread start. The shank thread starts are circumferentially spaced apart from each other by a shank thread start angle σ_{S}. The head and shank thread start angles σ_{H}, σ_{S}, are of 120°.

Preferably, each of the three head threads starts at the respective head thread start adjacent a head coupling rear end and extends forwardly to terminate adjacent the cutting-head shoulder.

If desired, the shank forward portion comprises a cylindrical relief bore extending rearwardly from the tool shank shoulder coaxially with the tool longitudinal axis T to merge with the shank coupling portion, so that a forward gap exists between the relief bore and the head coupling portion.

If further desired, the shank coupling portion extends rearwardly to a shank coupling rear end, and a rear gap exists between the head and shank coupling rear ends.

In another aspect, the present invention is directed to a cutting head having a head longitudinal axis H defining a front to rear direction, the cutting head comprising a three-start, threaded head coupling portion having three head threads.

### BRIEF DESCRIPTION OF THE DRAWINGS

For a better understanding of the present invention and to show how the same may be carried out in practice, reference will now be made to the accompanying drawings, in which:

FIG. 1 is a side view and a partial section view of detached cutting-head and tool shank of a cutting tool assembly in accordance with the present invention;

FIG. 2 is a rear view of the cutting-head shown in FIG. 1;

FIG. 3 is a front view of the shank shown in FIG. 1;

FIG. 4 is a side view and a partial section view of attached cutting-head and tool shank of the cutting tool assembly shown in FIG. 1.

### DETAILED DESCRIPTION OF THE INVENTION

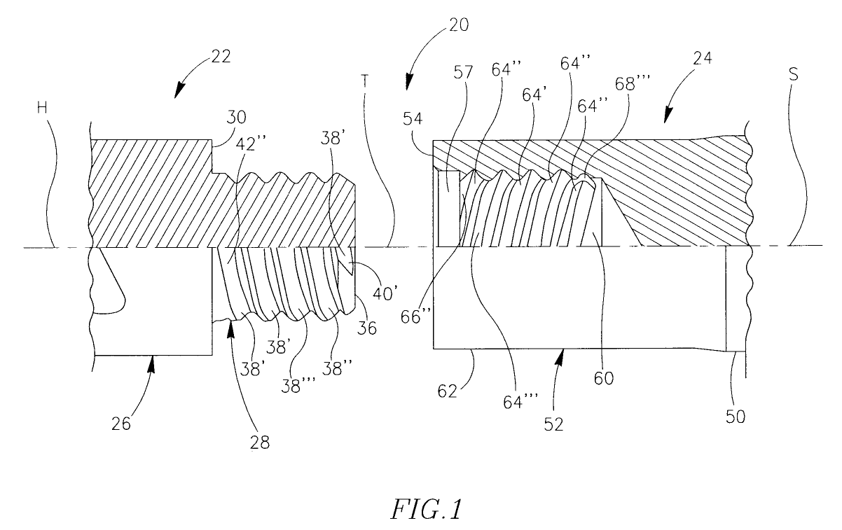

Attention is drawn to FIG. 1. A cutting tool assembly 20 is formed by detachably securing a cutting-head 22 to a tool shank 24. The cutting tool assembly 20 has a tool longitudinal axis T defining front-to-rear direction. The cutting-head 22 is preferably made of cemented carbide or other appropriate materials (such as ceramics or cermets).

The cutting-head 22 has a cutting portion 26 integrally formed with and extending forwardly from a head coupling portion 28. The cutting portion 26 and the head coupling portion 28 are coaxial, having a common head longitudinal axis H. The cutting portion 26 has a rearwardly facing, annular cutting-head shoulder 30 which is rotationally symmetric about the head longitudinal axis H and is perpendicular thereto. The head coupling portion 28 extends rearwardly from the cutting-head shoulder 30 coaxially with the head longitudinal axis H to a head coupling rear end 36.

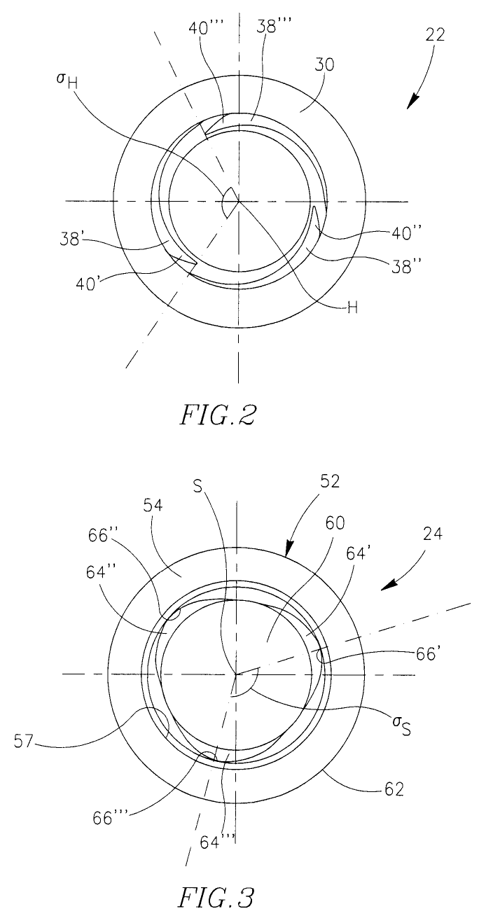

The head coupling portion 28 has the form of a three-start, threaded cylindrical stem, having three independent, substantially identical, parallel head threads 38′, 38″, 38″′ which are external, or “male”, threads. Each of the three head threads 38′, 38″, 38′″ starts at a head thread start 40′, 40″, 40′″ adjacent the head coupling rear end 36 and extends forwardly to terminate in a head thread end (only one head thread end 42″ is seen) adjacent the cutting-head shoulder 30. The head thread starts 40′, 40″, 40′″ are circumferentially spaced apart by a head thread start angle σ_{H} of 120° (FIG. 2).

The tool shank 24 has a shank body portion 50 which extends rearwardly from a shank forward portion 52. The shank body portion 50 terminates at a shank body rear end (not shown) adapted to be attached to a metal cutting machine (not shown). The tool shank 24, shank body portion 50 and shank forward portion 52 are coaxial, having a common shank longitudinal axis S. The shank forward portion 52 terminates in an axially forwardly facing tool shank shoulder 54. A shank coupling portion 56, in the form of a threaded cylindrical bore, merges with the tool shank shoulder 54 through a cylindrical relief bore 57 and extends rearwardly therefrom , terminating at a shank coupling rear end 60. The relief bore 57 and the shank coupling portion 56 are coaxial with the shank longitudinal axis S. The tool shank shoulder 54 is annular in shape, and extends radially outwardly from the relief bore 57 to a shank forward peripheral surface 62, and is rotationally symmetric with respect to the shank longitudinal axis S and perpendicular thereto.

The shank coupling portion 56 corresponds in shape and dimensions to the head coupling portion 28 and is designed to threadingly cooperate therewith. The shank coupling portion 56 has three inner, or “female”, substantially identical, parallel shank threads 64′, 64″, 64′″. The head and shank threads 38′, 38″, 38′″, 64′, 64″, 64′″ are trapezoidal threads. Each of the shank threads 64′, 64″, 64′″ starts at a shank thread start 66′, 66″, 66′″ adjacent the tool shank shoulder 58 and extends rearwardly to terminate in a shank thread end 68′, 68″, 68′″ adjacent the shank coupling rear end 60 (only one shank thread end 68′″ is seen in FIG. 1). The shank thread starts 66′, 66″, 66′″ are circumferentially spaced apart from each other by a shank thread start angle σ_{S} of 120° (FIG. 3).

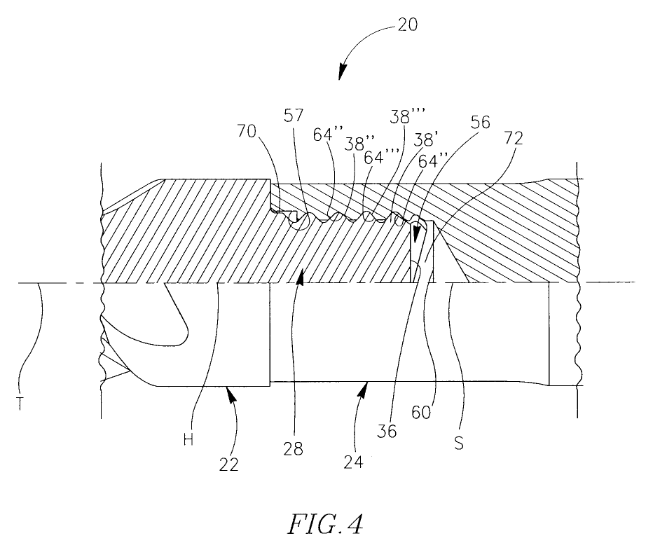

Attention is now drawn to FIG. 4. In order to assemble the cutting tool assembly 20, the cutting-head 22 is brought axially rearwardly towards the tool shank 24 so that the head coupling portion 28 passes through the relief bore 57 and enters the shank coupling portion 56. The cutting-head 22 is then rotated relative to the tool shank 24 so that the head threads 38′, 38″, 38′″ engage the shank threads 64′, 64″, 64′″. Rotation of the cutting-head 22 continues until the cutting-head shoulder 30 abuts the tool shank shoulder 54. The abutment between the cutting-head and tool shank shoulders 30, 54 provides the cutting-head 22 with axial support.

The cutting-head 22 and the tool shank 24 must be coaxially aligned to assure proper functioning of the cutting tool assembly 20. In the present invention, the coaxial alignment is provided by the threaded coupling of the cutting-head 22 and the tool shank 24. With the cutting-head 22 and the tool shank 24 threadingly engaged, each of the three shank threads 64′, 64″, 64′″ communicates with a corresponding head thread 38′, 38″, 38′″, to draw the head coupling portion 28 rearwardly into the shank coupling portion 56. In each cross-section, taken perpendicularly to the tool longitudinal axis T through the threadingly engaged head and shank coupling portions 28, 56, there are three contact regions at which the male and female threads abut. At each contact region, each female thread 64′, 64″, 64′″ exerts a clamping force on the abutting male thread 38′, 38″, 38′″.

Due to the trapezoidal shape of the male and female threads 38′, 38″, 38′″, 64′, 64″, 64′″, each clamping force has a centripetal clamping component which extends from the contact region towards the tool longitudinal axis T, in the plane of each cross-section. Therefore, the mutual engagement of the head and the shank threads 38′, 38″, 38′″, 64′, 64″, 64′″ centers the head coupling portion 28 relative to the shank coupling portion 56 at each cross-section, bringing the head and shank longitudinal axes H, S to coaxially align and form the tool longitudinal axis T, and assuring proper functioning of the cutting tool assembly 20.

When the cutting-head 22 is secured to the tool shank 24, a forward gap 70 exists between the head coupling portion 28 and the cylindrical relief bore 57, and a rear gap 72 exists between the head coupling rear end 36 and the shank coupling rear end 60, so that undesired contact between the cutting-head and shank coupling portions, which may adversely affect the axial alignment thereof with the tool longitudinal axis T, is prevented

The present invention potentially provides one or more advantages. Included among these may be providing positioning repeatability and coaxial alignment of the cutting-head relative to the shank of the cutting tool assembly, by employing the threaded coupling of the cutting-head and the shank as the centering and coaxial alignment means, thereby simplifying production of the cutting-head and shank.

Although the present invention has been described to a certain degree of particularity, it should be understood that various alterations and modifications could be made without departing from the scope of the invention as hereinafter claimed.

What is claimed is:

1. A cutting tool assembly having a tool longitudinal axis T defining front-to-rear direction and comprising a cutting-head threadingly secured to a tool shank;
the cutting-head comprising a three-start, threaded head coupling portion having three head threads; and
the tool shank having a shank forward portion comprising a three-start, threaded shank coupling portion having three shank threads.

2. The cutting tool assembly of claim 1, wherein the cutting-head comprises a forward cutting portion having a rearwardly facing cutting-head shoulder;
the tool-shank comprises a shank forward portion having a forwardly facing shank coupling shoulder in abutment with the cutting-head shoulder.

3. The cutting tool assembly of claim 2, wherein the cutting-head and tool shank shoulders are perpendicular to the tool longitudinal axis T.

4. The cutting tool assembly of claim 2, wherein the cutting-head and tool shank shoulders have an annular shape and are rotationally symmetrical with respect to the tool longitudinal axis T.

5. The cutting tool assembly of claim 1, wherein the three head threads have each a head thread start, the three head thread starts being circumferentially spaced apart from each other by a head thread start angle σH;
the three shank threads have each a shank thread start, the shank thread starts being circumferentially spaced apart from each other by a shank thread start angle σS, and the head and shank thread start angles σ_{H}, σ_{S}, are of 120°.

6. The cutting tool assembly of claim 5, wherein each of the three head threads starts at the respective head thread start adjacent a head coupling rear end and extends forwardly to terminate adjacent the cutting-head shoulder.

7. The cutting tool assembly of claim 2, wherein the shank forward portion comprises a cylindrical relief bore extending rearwardly from the tool shank shoulder coaxially with the tool longitudinal axis T to merge with the shank coupling portion, and
a forward gap exists between the relief bore and the head coupling portion.

8. The cutting tool assembly of claim 6, wherein the shank coupling portion extends rearwardly to a shank coupling rear end, and
a rear gap exists between the head and shank coupling rear ends.

9. A cutting head having a head longitudinal axis H defining a front to rear direction, the metal cutting head comprising a three-start, threaded head coupling portion having three head threads.

10. The cutting head according to claim 9, wherein the cutting-head comprises a forward cutting portion having a rearwardly facing cutting-head shoulder.

11. The cutting head according to claim 10, wherein the cutting-head shoulder is perpendicular to the head longitudinal axis H.

12. The cutting head according to claim 10, wherein the cutting-head shoulder has an annular shape and is rotationally symmetrical with respect to the head longitudinal axis.

13. The cutting head according to claim 12, wherein the three head threads have each a head thread start, the three head thread starts being circumferentially spaced apart from each other by a head thread start angle of 120°.

14. The cutting head according to claim 13, wherein each of the three head threads starts at the respective head thread start adjacent a head coupling rear end and extends forwardly to terminate adjacent the cutting-head shoulder.

15. The cutting head according to claim 9, wherein the three head threads have each a head thread start, the three head thread starts being circumferentially spaced apart from each other by a head thread start angle of 120°.

16. The cutting head according to claim 15, wherein each of the three head threads starts at the respective head thread start adjacent a head coupling rear end and extends forwardly to terminate adjacent the cutting-head shoulder.
